(19) United States
(12) Patent Application Publication
(10) Pub. No.: US 2025/0252823 A1
(43) Pub. Date: Aug. 7, 2025

(54) SYSTEM AND METHOD FOR OPERATING AND WAGERING ON A NOVEL SPORTS LEAGUE

(71) Applicant: JOHN KARAFILIS, LAND O'LAKES, FL (US)

(72) Inventor: JOHN KARAFILIS, LAND O'LAKES, FL (US)

(21) Appl. No.: 19/047,299

(22) Filed: Feb. 6, 2025

Related U.S. Application Data
(60) Provisional application No. 63/550,844, filed on Feb. 7, 2024.

(51) Int. Cl. G07F 17/32

(52) U.S. Cl. CPC G07F 17/3288

(57) ABSTRACT

A system and method for operating and wagering on a novel sports league. In a preferred, non-limiting embodiment, the novel sports league can incorporate and conduct golf long-drive events in which participants with similar average swing speeds can compete against each other. Men, women, and seniors may also compete against each other as equals within specific swing speed classifications. All competitors can be ranked (regardless of swing speed classification) based on their overall performance average, which can preferably include provisions for accuracy. The collection of statistical data from concluded events can permit proper scheduling of future events to assure further equity amongst all competitors and may also facilitate odds-making for wagering on a future event, which can include, but it not considered limited to, parimutuel wagering.

This application claims the benefit of and priority to U.S. Provisional Patent Application Ser. No. 63/550,844, filed Feb. 7, 2024, which is incorporated by reference in its entirety for all purposes.

### FIELD OF THE DISCLOSURE

The disclosure relates generally to operating sports leagues and more specifically to a system and method for operating a new long-shot golf inspired sports league and for allowing for wagering on outcomes of real time events involving the sports league.

### BACKGROUND

From a competitor perspective, professional golf has become a rewarding career choice for a few elite golfers but has become more and more of a “closed shop” to others seeking to participate at the professional golf level. Qualifying is now a very long, very expensive process, and what could once be accomplished with a modest entry fee and a single week of good play can now take years and hundreds of thousands of dollars to achieve. This has caused many hopeful golfers to give up on their dreams of participating at the professional level.

Many golfers who fail to gain status on a major tour seek other outlets to hone their skills while they wait for the next qualifying opportunity. Included in these outlets are “mini tour” golf and the sport of professional long-drive. Unfortunately, entry fees for most mini tour events can be excessively high (relative to purse payout) and professional long-drive is only an alternative option to the elite few who possess superior strength and speed.

From a viewer/bettor (i.e., gambling) perspective (aside from highlight footage and prop bets) both professional golf and professional long-drive are difficult to watch “live” and can take days before an outcome is achieved. Professional long-drive is even further hampered by its limited broadcast schedule and the monotony of ball-after-ball hit out of play by athletes who do not possess a professional level of proficiency at golf.

The current disclosure is directed to a novel system and method for operating a novel sports league incorporating certain characteristics of current professional long-drive though operating a league and events in a novel manner and for which novel wagering methods for such events can also be provided to interested individuals. Accordingly, the disclosed novel system and method addresses, or at least reduces, the issues and problems described above for competitors, viewers, and bettors alike.

### SUMMARY OF THE DISCLOSURE

A novel system and method for operating and wagering on a novel sports league is described and disclosed herein. In a preferred embodiment, the game or event played for the novel sports league can incorporate one or more aspects or features from professional golf and long-drive events. Though the disclosure is not considered limited to just a professional long-drive league, the operation and functionality of the disclosed system and method will be described in connection with a novel golf/long-drive sports league that is also disclosed and described herein.

The disclosed novel golf long-drive league can offer paid (i.e. preferably on a contractor/independent contractor basis as opposed to employees) opportunities for professional level golfers to compete for prize money against their peers, regardless of age or sex, in multiple, daily broadcast, 5-minute events, with minimal qualifying and no entry fees. As described in more detail, the novel long-drive league is not necessarily limited to professional level golfers and participants for a particular specific competition or event who can be preferably selected and chosen based on certain criteria to allow for evenly matched or more competitive events between participants across all skill levels in one embodiment, though not limiting. Lesser skilled individuals may also be allowed to compete in the same league as higher skilled individuals, such as at the discretion of the league. Furthermore, certain events may combine or join individuals of different skilled levels into the same event, such as, the situation where professional-level golfers and a celebrity (though having different skill levels) are grouped together into the same event.

In one non-limiting embodiment, the disclosed novel sports league allows for professional level golfers to compete for prize money against their peers, regardless of age or sex, in multiple, daily broadcasted, relatively short time period events (e.g. 5 minutes, etc.), with minimal qualifying and preferably no entry fees.

The foregoing and other objects, features, and advantages of the invention will become more apparent from the following detailed description, which proceeds with reference to the accompanying figures.

### BRIEF DESCRIPTION OF DRAWINGS

FIG. 1 illustrates a block diagram and process flow for scheduling an event for the novel sports league in accordance with the current disclosure;

FIG. 2 illustrates a block diagram and process flow for making odds for the participants in the event preferably for wagering purposes in accordance with the current disclosure;

FIG. 3 illustrates a block diagram of the primary electrical/electronic components preferably present at the event for broadcasting, monitoring, recording, data collecting, overseeing, etc. the event; and

FIG. 4 illustrates a block diagram of the primary electrical/electronic components preferably present at the event where a golf simulation device is used for at least some of the competition during the event.

### DETAILED DESCRIPTION

A system and method for operating a novel sports league and wagering on events conducted by the sports league is disclosed herein. In a preferred embodiment, the novel sports league can be based on golf long-drives. Any number of players/participants can be included in the league and is considered within the scope of the disclosure. Preferably, the league may comprise roughly 96 fully-exempt, independently contracted, male and female professional-level golfers, who can compete in head-to-head events for money. The novel format used for operating the league, including player rankings and matching and determining which players compete against each other, can be specifically structured for odds-making, gambling, broadcast, and licensing.

As noted above, each event can be a Professional Golf Long-Drive Competition preferably featuring competitors within a specific Swing Speed Classification (SSC). Though not considered limiting, an example of baseline classifications (B) that can be used can be set as follows:

| | |
|---|---|
| CLASS 1B | Below 90.0 mph |
| CLASS 2B | 90.0 mph-99.9 mph |
| CLASS 3B | 100.0 mph-109.9 mph |
| CLASS 4B | 110.0 mph-119.9 mph |
| CLASS 5B | 120.0 mph-129.9 mph |
| CLASS 6B | 130.0 mph and Above |

Preferably, each event for the league can be based on the SSC, though it is also within the scope of the disclosure to use other criteria for determining participants for each event. Preferably, men, women, and seniors may compete against each other (i.e., where their SSC all fall within the same baseline). It is also within the scope of the disclosure that certain specific events may be scheduled throughout the season based strictly on age and/or gender.

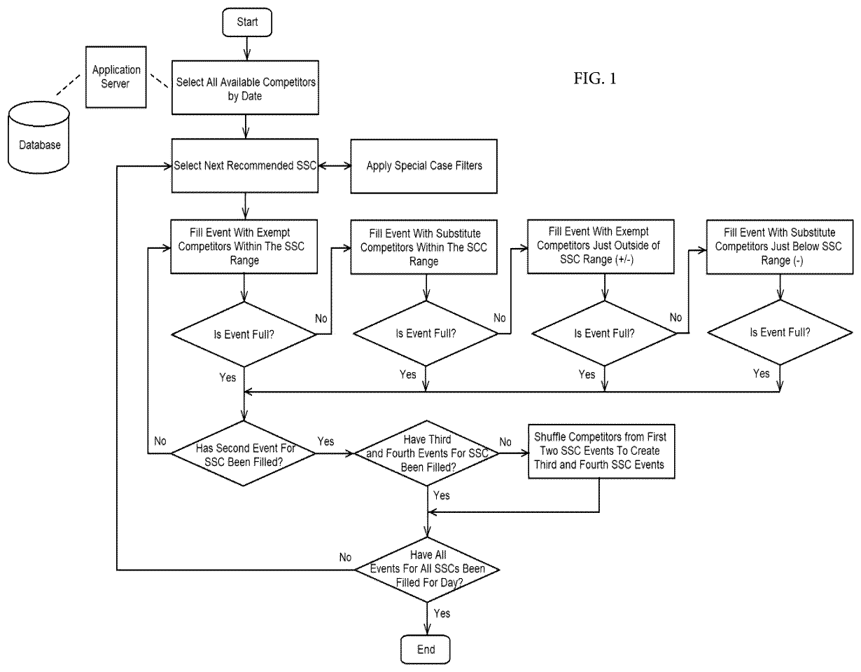

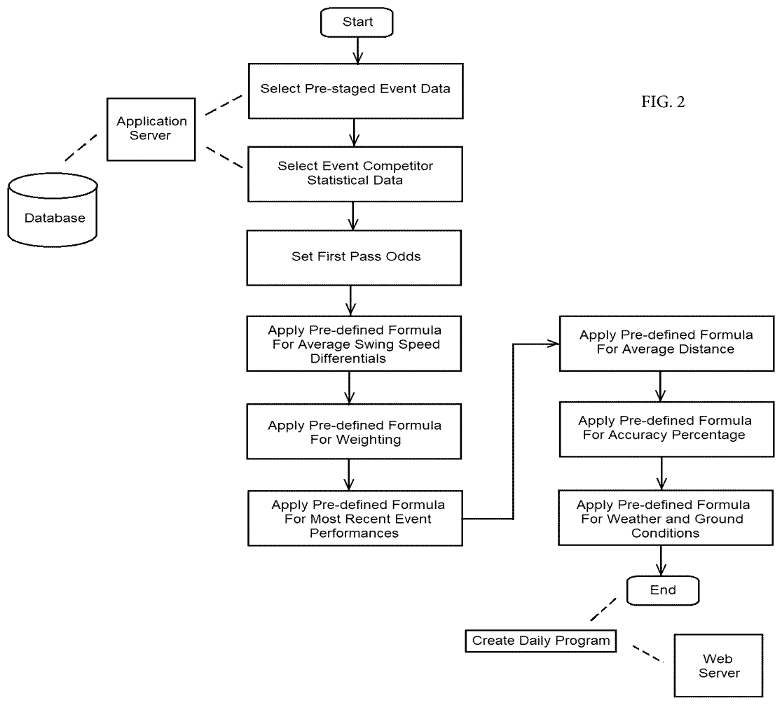

Each (broadcast) competition day may consist of roughly 8 events, each event may consist of roughly 8 competitors, and each event can preferably run for a maximum duration of 5 minutes (with a preferred 15-20 minute “break-period” between events). More details for how the events are preferably set up using the novel system and method are described below in connection with the discussion of FIG. 1. A morning line (odds) can be set for each SSC rated event and discussed in more detail below in connection with FIG. 2. Based on the results of prior/past events, event SSCs can be preferably periodically automatically adjusted downward (A) or upward (C) by the system. Though not limiting, adjustments can be by approximately 5-mph adjustments, with occasional longshot and heavy favorite competitors added to an event. The above-described time periods, number of events, number of participants, amount of adjustments, etc. are all by way of non-limiting example, and other higher or lower values can also be used and all are considered within the scope of the disclosure.

Competitors/participants can be ranked throughout the course of the season (such ranking can be automatically adjusted by the system based on past performances in events) based on their respective Performance Average (PA). The PA can be preferably calculated using the following formula:

$$PA = Number of Seasonal Points Accumulated / Number of Seasonal Events Participated In$$

Overall PA does not need to be based on SSC, gender, or age. Rather, overall PA can be preferably based on how well an individual performs in every event relative to their respective SSC peers who participated in the same events as the individual. The system can automatically adjust an individual's overall PA preferably after each event as the information and data from such event is fed or input (preferably automatically) into the system at the conclusion of the event.

Points can be awarded by the system preferably based on an individual participant's finishing position and accuracy for each event, for each individual participating in the event. Competitor remuneration can also be automatically determined by the system and can be preferably also based on finishing position and accuracy for each event.

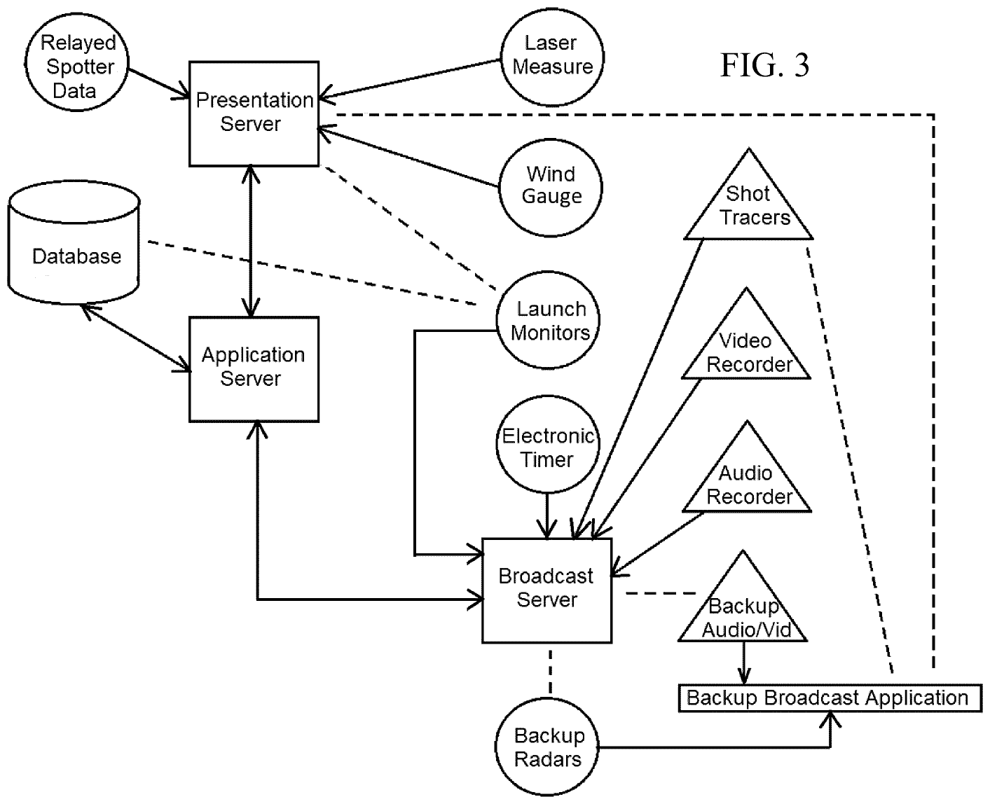

As data can be preferably automatically collected and stored/saved by the system throughout the course of the season, swing speed averages of competitors can be preferably automatically adjusted accordingly by the system, which allows for proper event scheduling amongst SSCs. Accordingly, the operation of the novel sports league preferably relies on data being automatically collected by the system (See FIG. 3) for each event and the operations performed by the system as the new data is collected and received by the system.

The system can be programmed and/or configured for automatic receipt and processing of electronic data received from electronic devices (see FIG. 3) located at the events and can automatically perform the following, but not limited to, functions:
1. Receiving and processing of competitor/participant statistics (all statistics gathered at each event), which can include the tracking of statistics that fall outside of the statistical norm of each competitor.
2. Hosting and automatically updating competitor public facing information (current PA, current SSC, number of wins, place, shows, accuracy percentage, distance average, etc.).
3. Event scheduling determinations, which preferably considers competitor SSC ratings and availability, event SSC rating requirements, adjustments due to the number of available competitors meeting the SSC ratings on any given day, and may require the flexibility to accommodate gender, age, and the prospect of substitute competitors and/or the addition of longshot and/or heavy favorite competitors.
4. Determinations and settings of the morning line (i.e. player/participant odds for each event set for the day).
5. Creating a daily (digital) program for the events occurring on such day, which may include the morning line for such events, and which can be automatically prepared and sent to subscribers and other determined individuals.

Preferably, every competitor contracted to compete in the league (which preferably can also include any possible substitutes or special guests) is evaluated and rated by the system/individuals associated with the league. Preferably, each competitor can be required to also meet the minimal requirements of professionalism set forth by the league and/or league partners/sponsors. Though not limiting or inclusive, such requirements of professionalism my include the following:
1. Preferably, each player can be a professional-level golfer (i.e., capable of near-scratch or better performances at some point in their respective competitive careers). The requirements for determining “professional” can be at the sole discretion of the league and may be based on verifiable current and past performance for a player. The threshold for determining “professional” may also be affected by the number of players seeking to participate in the league. Where an abundance of players is available, the “professional” qualification may be more rigid/stringent, as compared to situations where not enough players are available.
2. Preferably, each player must maintain a minimal professional standard of accuracy throughout the competitive season, as foul-balls are not conducive for competitive play or the broadcast environment. Based on data automatically received by the system during and/or at the conclusion of each event, the system can be configured to automatically track and accumulate the number of foul-balls hit by a player during an ongoing or concluded season and can also be configured to issue digital alerts/warnings/notifications to the player and/or league representatives where a player has exceeded a predetermined/present number of foul-balls for an event and/or for a season.
3. Players preferably should also exhibit the ability to follow event protocols and standards required by the league and/or the league partners/sponsors.
4. Players should maintain minimal standards of professional conduct and appearance, with decisions preferably being the sole discretion of the league and/or the league partners/sponsors.

To help assure or achieve parity in seasonal Performance Average (PA) amongst all league competitors, the following elements preferably can be incorporated and configured and used by the system:
1. A graduated-width fairway can be preferably used, which can ensure that an (up to) 2-degree accuracy mis-strike can be rewarded/penalized equally amongst all SSCs.
2. Competitors can preferably hit/participate in a multitude of A, B and C SSC rated Events to preferably bring their overall average swing speed differentials (amongst their peers) closer to a 5-mph spread and/or as close together as possible for the course of the season.
3. Competitors can be penalized for anomalous swings that do not fall within their respective statistical norms.

Preferably, “current” competitors who finish in the top half of the season ending Performance Average points list (and meet the minimum requirements for accuracy, conduct, and appearance) can be automatically identified by the system and/or offered contracts for the “next” season. This criteria for qualifying for the following season is not considered limiting and other criteria can be used instead and all are considered within the scope of the disclosure.

In addition to the automatically qualifying participants, additional “next” season contracts can be awarded by SSC B Classification qualifying events (i.e. preferably based on the number of spots available for the “next” season in each SSC B Classification).

Preferably, all contracted competitors can be paid a base (minimal) fee for their appearance in each event in addition to any additional compensation for winning or awards from the player's performance in the event.

For purposes of aiding in the understanding of the description of the system and method, including a more detailed description of the drawings below, the following Glossary of Terms are provided, which terms are not considered restrictive or limiting in any manner, and should be given their broadest interpretation:
a. Long-Drive—A sport in which individuals compete against each other in an effort to hit a golf ball as far as possible into a pre-defined area, such as a fairway. The individual who hits his/her golf ball the furthest, within the confines of the pre-defined area/fairway, wins.
b. Fairway—A shortly-mown area of manicured grass (or like synthetic material) whose boundaries are typically defined by an area of longer grass (or by other markings, such as painted lines, etc.). For purposes of the instant description a fairway can also be considered to include other real or synthetic grass areas that are otherwise marked or provided with boundaries for which a golf ball must finish within to be considered in play.
c. Accuracy Percentage—This is the percentage of fairways hit by a competitor for all Events in a Season.
d. Electronic Measuring Devices—These include, but are not limited to, doppler radars, lasers, launch monitors, high-definition cameras, wind gauges, etc.
e. Statistical Data—This is data gathered on/for every competitor during initial evaluations, qualifying, and participation in Events which includes, but is not limited to, swing speed, ball speed, fairways hit, driving distance, Event placement, monies won, status, weather conditions, etc.
f. Average Swing Speed—The speed at which an individual typically swings his/her driver during a competitive event.
g. Swing Speed Classification (SSC)—A predefined range of speeds in which individuals are expected to swing within during a competitive event. For example: SSC2=90.0 mph-99.9 mph, SSC3=100.0-109.9 mph, SSC4=110.0-119.9 mph. If an individual's Average Swing Speed was 104.3 mph, he/she would be preferably rated for competition in events designated SSC3.
h. Event—For the purpose of this disclosure, an event is defined as a long-drive competition amongst individuals within a specific Swing Speed Classification (SSC).
i. Special Case (Event)—For the purpose of this document, this is a subset of an Event. In a Special Case Event, individuals within the Event SSC may be further segregated by other categories such as, but not limited to, age, sex, Performance Average, accuracy percentage, number of wins, etc.
j. Exempt Competitor—An individual who is eligible to compete in every Event scheduled for his/her Swing Speed Classification (SSC) for a pre-defined season.
k. Substitute Competitor—An individual who is only eligible to compete in Events in which a spot has been vacated by, or otherwise not filled by, an Exempt Competitor (Note: Swing Speed Classification ratings can also apply to Substitute Competitors).
l. Season—A pre-defined or pre-configured period of time, which can be measured in weeks or months, in which a multitude of Events can be held for all Swing Speed Classifications (SSCs). At the beginning of each Season, competitors can start on equal footing. Competitors are awarded performance points at Events throughout each Season. Competitors who earn enough performance points by the end of the Season can earn or be offered Exempt status into the following Season.
m. Performance Average (PA)—This is the average number of points a competitor earns per event throughout the course of a Season. Performance Average is the standard by which all competitors are measured against each other.
n. Equity—For the purpose of this disclosure, a dynamic movement of SSC Event scheduling by the system to assure that competitors' average swing speeds are much closer, on average, to those of their competitive peers over the course of a Season.
o. Weighting—For the purpose of this disclosure, an additional rating applied to a competitor by the system in an Event if the competitor's average swing speed falls outside of the SSC range of the Event. Weighting can be classified as heavy longshot (HLS) or longshot (LS) for average swing speeds that fall below the Event SSC rating, and favorite (F) or heavy favorite (HF) for average swing speeds that exceed the Event SSC rating.
p. Odds/Odds Making—For the purpose of this disclosure, odds can be referred to as a “morning line”. A “morning line” can be an initial, calculated odds for each competitor in an Event based on that competitor's Performance Average, average swing speed, Accuracy Percentage, and the like, and serve as a starting point reference for potential wagering and/or Parimutuel Bettors.
q. Parimutuel Betting—Can also be referred to as “pool betting” and can be a form of gambling where the odds are preferably not fixed, but instead can fluctuate based on bettor participation. Monies can be collected in a general pool. Taxes and a “house-cut” can be removed from the pool first before “winnings” for an event are distributed to winning bettors/gamblers. Thus, after deducting taxes and preferably also a house-cut, the remaining monies in the pool can be shared amongst the winning bettors. The various collections, calculations, tax/house cut deductions, distribution of winnings, etc. can all be calculated, controlled and/or initiated by the system and/or an electronic system of any contracted or partnered third party entity, though the disclosure is not considered limited to having to use a system for one or more of the following: collections, calculations, tax/house cut deductions, distributions of winnings, etc.

r. Daily Program—For the purpose of this disclosure, can be a digital document that is written for each Event and made available to the public by the system. The digital document can contain the “morning line” competitor Odds for each Event (preferably for the day though not considered limiting), as well as statistical and biographical data for every Event competitor.

As described above and below, the disclosure describes a novel system and method for conducting and/or wagering on a sporting activity, and in the described non-limiting example uses a novel sports league that can preferably only involve golf long-drives, as opposed to a traditional game of golf. The league can preferably be operated and conducted through an electronic system to create a preferably equitable, yet highly competitive environment for its participants, while also permitting for a relatively fast-paced entertainment broadcast conducive to sports wagering. In a preferred embodiment, the league can comprise highly skilled (professional level) golfers, who can be grouped together by the electronic system based on their respective average driver swing speed (herein referred to as “Swing Speed Classification”, or “SSC”), to allow participants to compete directly amongst their swing speed peers within a like or same SSC level. The competitions (herein referred to as “Events”) can be long-drive contests within a designated SSC and can be structured to conclude within several minutes. Given the relatively short time period for each Event, multiple Events can be held each day, with each day preferably featuring a variety of SSC ratings/levels and associated competitor pairings. Points can be awarded to competitors by the system for distance and accuracy at each Event, and all relative data from the Event can be fed, transmitted (i.e. wired or wirelessly) and/or input into the system from the Event regarding each competitor's performance and Event conditions (i.e. wind, rain, etc.). Preferably, all competitors, regardless of age, sex, or SSC can also compete against each other seasonally for the highest Performance Average (PA) even if the competitors don't compete directly against each other in Events during the season, as the PA can be the average amount of points each competitor earns per event for the entire Season.

For operation of the league the system preferably collects and uses various Event driven statistical data. Though not limiting, this data can be used for Event scheduling, odds-making, participant selection for an event, the ranking of competitors throughout the course of each Season, etc. From a competitor perspective, one main ranking can be Performance Average (PA), which is determined by the system and can be used as the barometer for competitor longevity (i.e. Exempt status) within the league. Preferably, Performance Average (PA) is not based on SSC, gender, or age, but rather can be based on how well an individual performs in every event they participate in relative to their respective SSC peers. PA can be calculated by the system using the following equation:

$$PA = Number of Seasonal Points Accumulated / Number of Seasonal Events Participated In$$

Points can be awarded to the participants of an Event by the system based on each competitor's finishing position and accuracy count (i.e., in play—on the fairway) for each Event they participate in. Competitor remuneration can also be determined by the system based on participation, finishing position, and accuracy count for each event.

In addition to PA, competitors can also be ranked throughout the course of each season in one or more of the following, non-limiting categories:
1. SSC (i.e. current average swing speed)
2. Wins, places, shows, and 4^{th} place finishes
3. Average distance
4. Accuracy percentage
5. Earnings
   All of the above Rankings, except for Earnings, can be used by the system when determining odds-making for the participants of an Event, with SSC preferably playing a primary role in Event Scheduling.

As seen in FIG. 1, Event scheduling can be a multi-tiered process that is performed by the electronic system which can take several elements into account, including (though not limiting) competitor availability within a given SSC for each day, the dynamic movement of average swing speeds for competitors over the course of a given season, equitable distributive placement amongst competitors within SSC categorized events, and the creation of events that contain both familiarity (to encourage both consumer and sponsor loyalty) and a healthy mix of variety (to offer consumers the excitement of both tightly packed finishes and the possibilities of both longshot and heavy favorite wagering).

A non-limiting, Event Scheduling example is described below and can use the following non-limiting definitions and non-limiting assumptions for illustrative purposes:
a. A Season can be defined as a 24-week period.
b. There can be six (6) baseline (B) classification (SSC) ratings per season.
c. Baseline (B) SSCs can be as follows:
   CLASS 1B Below 90.0 mph
   CLASS 2B 90.0 mph-99.9 mph
   CLASS 3B 100.0 mph-109.9 mph
   CLASS 4B 110.0 mph-119.9 mph
   CLASS 5B 120.0 mph-129.9 mph
   CLASS 6B 130.0 mph and Above
d. Downward adjusted (A) SSCs can be as follows:
   CLASS 1A Below 85.0 mph
   CLASS 2A 85.0 mph-94.9 mph
   CLASS 3A 95.0 mph-104.9 mph
   CLASS 4A 105.0 mph-114.9 mph
   CLASS 5A 115.0 mph-124.9 mph
   CLASS 6A 125.0 mph and Above
e. Upward adjusted (C) SSCs can be as follows:
   CLASS 1C Below 95.0 mph
   CLASS 2C 95.0 mph-104.9 mph
   CLASS 3C 105.0 mph-114.9 mph
   CLASS 4C 115.0 mph-124.9 mph
   CLASS 5C 125.0 mph-134.9 mph
   CLASS 6C 135.0 mph and Above
f. There can be 16 Exempt and 8 Substitute competitors per baseline (B) SSC classification rating per season, for a total of 144 available competitors per season.
g. There can be 2 SSCs with 16 competitors per SSC on property per Event day.
h. An Event can be comprised of 8 like-SSC competitors.
i. An Event day can be comprised of 8 Events.

Preferably, at the beginning of each season, a Seasonal Events Classification table can be created and used by the system as a base reference to help facilitate competitor Equity in Seasonal scheduling. This table can also be referenced by the main Event daily scheduling program created by the system to give competitors the opportunity to compete in 8 weeks of rotational (A), (B), and (C) rated SSC events, assuring or helping to assure that competitors can be continually mixed within event SSCs based on their current average driver swing speed (i.e. it increases the probability that each competitor can participate in an equitable number of events where he/she resides in the bottom, middle, and/or top portion of the swing speed range of said Events, thereby negating or helping to negate a large portion of the preferred 10 mph differential between the lower and upper speed range of each SSC over the course of a Season).

Most, if not all of the Seasonal Event scheduling can be performed by novel algorithms of a computer program running on an electronic system, such as, but not limited to, a computer. One or more of the algorithms for the computer program can be specifically designed for the daily scheduling of events. The computer program/system can contain an interface with input parameters for SSC, date, special case scenarios (such as filtering by age, sex, etc.), and the maximum number of competitors per event (wherein can be configured to default to 8 as a non-limiting example).

As seen in FIG. 1, the steps performed by the novel Daily Event Scheduling algorithm can flow as follows:
a. Get the next designated SSC rating for 4 Events (reference the Seasonal Events Classification table) (4 Events or any other number discussed herein is not considered limiting and chosen as a non-limiting example for illustrative purposes).
b. Get available (preferably all available) Exempt and Substitute competitors from the competitor statistics and availability tables (by Event date), and filter by special case scenario when applicable.
c. Attempt to fill the first of 4 events with 8 SSC eligible competitors for each event:
   i. Exempt competitors with lowest total Event participation count can get priority and the system configured accordingly
   ii. Randomize the other Exempt competitors
   iii. If Event fills upper limit within SSC—STOP
   iv. If Event does not fill upper limit within SSC
      (1) Run the Substitution competitors through steps i-iii above
      (2) If the Event has at least 8 competitors-STOP
      (3) If the Event has less than 8 competitors:
         1. Look for Exempt competitors who have flagged their accounts for as much competition time as possible
         2. From this group (1) look for Exempt competitors who are +/−2.5 mph within upper and lower SSC Event range.
         3. If found, follow steps i-iii above and mark the added Exempt competitor as longshot (LS) or favorite (F)
         4. If the Event has at least 7 competitors—STOP
         5. If the Event has less than 7 competitors:
         6. From this group (1) look for Exempt competitors who are +/−5 mph within upper and lower SSC event range.
         7. If found, follow steps i-iii above and mark the added Exempt competitor as heavy longshot (HLS) or heavy favorite (HF)
         8. If the Event has at least 6 competitors—STOP
         9. If the Event has less than 6 competitors:
         10. Gather available Substitute competitors in next lower SSC and run through steps i-iii above (if added, mark as LS or HLS accordingly)
         11. If the Event has at least 6 competitors—STOP
         12. If the Event has less than 6 competitors
         13. Flag for manual review and possible manual substitution
   v. Eliminate the scheduled competitors from further processing in steps b-c.
d. Schedule the second of 4 SSC Events by repeating steps b and c above for the remaining available competitors.
e. From the two SSC Events that have been scheduled, randomize the competitors from each Event and split them to create the remaining two Events for that SSC. A non-limiting example can be to place all of the even numbered competitors into the third Event, and all of the odd numbered competitors into the fourth Event.
f. Repeat steps a-e above for the next SSC referenced in the Seasonal Events Classification table.

With respect to odds making by the system for the Events, preferably the system can create and present daily Events for which the system will use existing data for creating the odds of one or more, and preferably all, participants competing in each Event. The data can be considered dynamic as it is constantly being updated to include performance and data statistics for recent and newly completed Events by each participant. Preferably, each Event can be scheduled by the system to start at a specific time of day, followed by a break-period before the start of the next Event. In addition to a daily Event schedule, a daily “digital program” can be created for each Event by the system, which can provide details of the Event parameters (such as, but not necessarily limited to SSC), Event competitor information (such as most recent Event results), and the initial betting Odds for each competitor (which can be referred to as the “morning line”) can also be provided.

Odds making for the morning line can be preferably based on gathered or collected and preferably stored statistical data for each competitor and can consider data and information related to current competitor rankings in SSC, Event finishes, average distance, and accuracy percentage. A novel software algorithm can be preferably provided for use by the electronic/computer system in determining the odds making for an Event by the system (i.e. for creation by the system of the Event's morning line). Preferably, a user interface can also be provided with preferably the parameters of date and Event number.

As seen in FIG. 2, the steps involved for the novel odds making algorithm can comprise:
a. Select Event information from pre-staged data relative to each scheduled Event.
b. Select competitor statistical information gathered from previous Events and/or evaluations and qualifying.
c. Rank the event competitors against each other by comparing one or more data points, which can preferably include, but is not necessarily limited to, PA, swing speed average, average distance, event finishing positions, and accuracy as follows:
   i. Set the first pass odds to 1-1, 2-1, 3-1, 4-1, 5-1, 6-1, 7-1, and 8-1 preferably based strictly on average swing speed (where 8 competitors are participating in the event), with ties receiving the same first pass odds (as a non-limiting example: 1-1, 2-1, 3-1, 3-1, 5-1, 6-1, 7-1, 8-1, which shows competitors occupying the 3^{rd} and 4^{th} spot in the order who share the same average swing speed).
   ii. Use pre-defined or pre-configured formula to further expand or contract the odds based on differentials between competitors' average swing speeds.
   iii. Use the pre-defined or pre-configured formula to further expand or contract the odds for each competitor based on Weighting.
   iv. Use the pre-defined or pre-configured formula to further expand or contract the odds for each competitor based on most recent Event performances.
   v. Use the pre-defined or pre-configured formula to further expand or contract the odds for each competitor based on average distance.
   vi. Use the pre-defined or pre-configured formula to further expand or contract the odds for each competitor based on accuracy percentage.
   vii. Use the pre-defined or pre-configured formula to further expand or contract the odds for each competitor based on the predicted event weather and ground conditions (if available/applicable).

On an actual event day, with the various electronic devices and systems seen in FIG. 3 in position for use during the event, various statistical data from the Event can be collected, received by and stored by the system. The obtained data from the Event allows the system to properly group competitors by SSC, determine competitor rankings across the Season (by PA), create equitable scheduling of SSC rated Events, perform Odds-making, and perform real-time tracking of competitor positions during Event broadcasts.

Preferably, one or more, and possibly all Events, can be broadcast live, using one or more current technologies, cable, streaming/Internet, satellite, etc. as well as future technologies later developed. As a non-limiting example, each Event day can be comprised of a minimum number of Events (e.g. 8 Events, etc.) that can be preferably spread across at least two distinct SSCs. Each Event can be staged for a specific SSC, and can flow as follows using 8 Events as a non-limiting Example:
1. The Event is prepared for broadcast.
2. The Event competition clock starts.
3. Preferably, the first two competitors hit balls side-by-side within their allotted time-period.
4. Preferably, the next two competitors hit balls side-by-side within their allotted time-period.
5. Preferably, the next two competitors hit balls side-by-side within their allotted time-period.
6. Preferably, the final two competitors hit balls side-by-side within their allotted time-period.
7. The Event competition clock stops, and the competition period ends.
8. Distances are measured and all pertinent statistics are collected and can be transmitted or otherwise sent or forwarded and received by the system.
9. The Event is finalized.

The live broadcast of each Event preferably can start and end at specific, designated times. To ensure or help ensure an efficient and timely Event, a myriad of processes can be used, including computer driven processes to work together in a coordinated fashion. FIG. 3 shows a block diagram schematic of preferred, though non-limiting, primary electronic devices and components used for operating, setting and broadcasting the Event(s). Each of the above listed 9 steps for the Event will be discussed in further detail below in connection with the electronic device/components seen in FIG. 3. The below discussion assumes that all of the electronic devices and components are properly connected and properly electronically communicating with each other and operating correctly at the beginning of and throughout the Event day.

To prepare the Event for broadcast, the Event staff can preferably log into the Presentation Server and retrieve data for each Event competitor. The Presentation Server can electronically communicate this request to the Application Server, which electronically retrieves the competitor data from a Database and sends/forwards/transmits the data preferably to both the Presentation Server, as well as a Broadcast Server. The Event staff can complement this retrieved data with additional (manual and electronic) Presentation Server entries, such as, but not limited to, wind speed, temperature, ground conditions, and the like. Some or all of the retrieved and entered data can be sent/transmitted/forwarded to the Broadcast Server via the Application Server. Once all required or requested data is properly staged, the broadcast of the Event can begin. Preferably, the staging of the data can be completed prior to the scheduled start time for the Event.

Though the servers described and shown in FIG. 3 can be organized, presented and used in a multi-tiered architecture configuration/scenario for the various functions performed by the novel system and method, such is not considered limiting, and other hardware/software architecture/platforms/configurations can be used and are also considered within the scope of the disclosure, which can also include cloud computing/servers. Depending on configurations selected, at least some of the hardware/software can be remotely located and other hardware/software located on-site at the Event, though such is not considered limiting. Though databases can be used for storing data, such is not considered limiting, and other storage technologies, including, but not limited to, flash and/or cache memory, such as those: residing on dedicated blade servers—can also be used and reside on-site or remote to the Event location. Accordingly, it should be recognized that the novel functions and novel operations of the system and method are not limited to any one particular type of computer hardware and/or software configuration or implementation.

Competitors (preferably two at a time—though not considered limiting) enter the competition area and prepare to hit. Their movements can be picked up by the Video/Audio recorders/sensors and transmitted to the Broadcast Server. Pertinent data relative to these two competitors can also be displayed to the broadcast viewers by the Broadcast Server. At the designated time, the Event's Electronic Timer starts the Event competition clock (displayed to the viewer via the Broadcast Server) and the competition is underway. The system can be configured to automatically cause the Electronic Timer to start the Event Competition clock at the predetermined start time for the particular two competitors, to help aid in keeping the Event moving forward according to schedule.

As each Event competitor strikes each shot, the positioned/provided Shot Tracers and Launch Monitors can be triggered and relay their respective data to the Broadcast Server, which displays the relevant, real-time trace and speed data to the broadcast viewer for each ball struck by each competitor. In conjunction, the Event staff can also enter swing speed data and shot validity into the Presentation Server or sensors/monitors can also be provided for automatically obtaining and entering such data. Estimated distance and accuracy data can also be relayed by Spotters in the field of play to the Event staff, who manually into enter this data the Presentation Server or sensors/monitors/drones/satellites, etc. can also be provided for locating the hit ball in the field and automatically calculating and entering the distance information/data. The estimated distances or determined distances can then be relayed to the Broadcast Server via the Application Server. The Broadcast Server can display the estimated distances/determined distances and current competitor standings to the broadcast viewer.

The above steps and data collection descriptions for the first two competitors can then be repeated for the next two competitors, followed by the next two competitors and followed by the final two competitors (for an 8 competitor Event) and such description is incorporated by reference for the other competitors.

The Electronic Timer can be configured to automatically signal the end of the competition period to the Broadcast Server, and the Broadcast Server can display the (temporary) estimated competitor distances or determined distances and competitor positions for the Event to the broadcast viewer.

Where estimated/temporary distances are initially provided, more accurate distances can be quickly measured for each Event competitor by a measuring device, such but not limited to, a laser (for accuracy) and preferably immediately reported to the Event staff from Spotters in the field of play or entered into the system through the servers by the Spotters using portable electronic devices on their person. Where the data is sent to Event staff, the Event staff can enter the distance data/information into the Presentation Server, where they are immediately transmitted by the Application Server to the Broadcast Server, as well as saved into the database for use in updating competitors' PA, SSC, etc. The Broadcast Server can display these as preliminary results to the broadcast viewer. Spotters in the field of play can also relay any remaining statistical data to the Event staff or enter such information into the system using their portable electronic devices and confirm all of their reported data. Where the data/information is provided to the Event staff from the spotter, the Event staff can enter this confirmed data into the Presentation Server and can await final sign-off.

The Event coordinator or system can preferably immediately review the data/information collected at the Presentation Server and can compare it with the data collected and staged at the Broadcast Server. If the data does not match within a statistical norm, a review can be conducted. If the data matches within the statistical norm, the Event can be finalized, and confirmation can be sent to the Broadcast Server from the Presentation Server via the Application Server. All statistical data collected at the Presentation Server can then be saved to the Database via the Application Server, if not already saved.

Preferably, the Event broadcast can be loaded with redundancy to ensure the transmission of a live Event stream. These redundancies consist of both manual contingencies and electronic backups, some of which are depicted in FIG. 3.

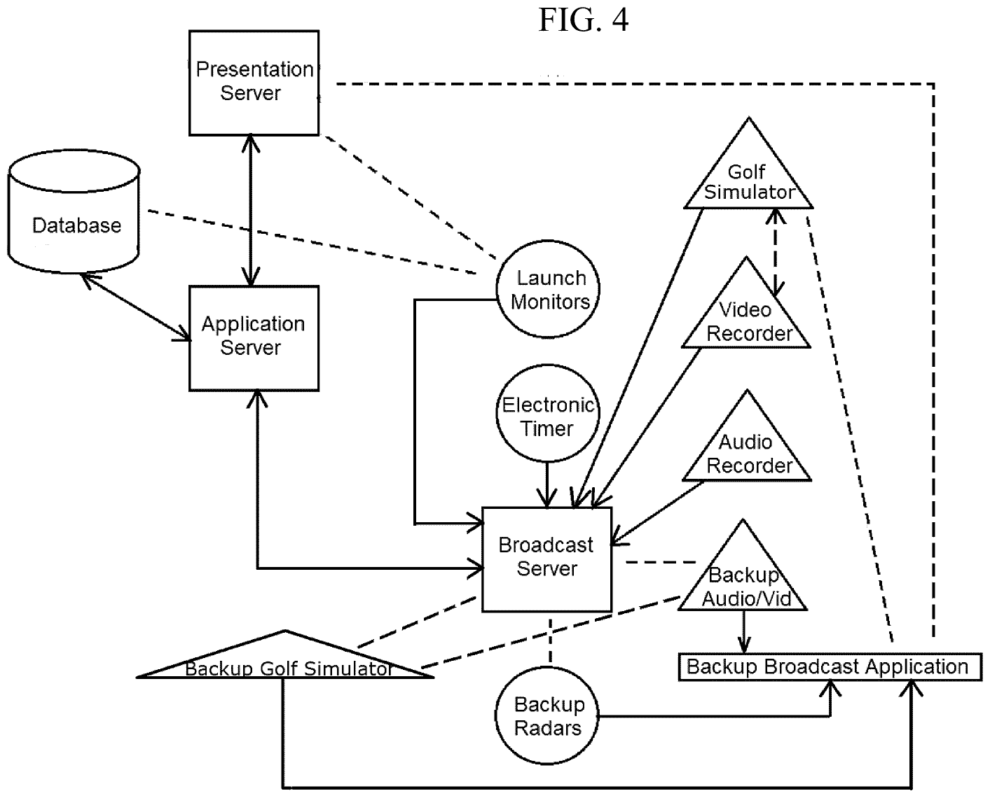

As seen in FIG. 4, all or some of the events for the competition may be contested or provided in a simulated or virtual/metaverse environment, instead of or in addition to/combination with a traditional outdoor competition fairway. This simulated environment may consist of a single golf simulator or the like, multiple golf simulators or the like networked together, or any other configuration of golf simulators or the like that might be necessary to encapsulate the previously defined league protocols. For the purpose of this disclosure, the term golf simulator can be considered to imply or include, without limitation, a simulated electronic environment and shall apply to one or more golf simulators or the like in any configuration.

In the simulated environment, the event competitors can hit shots side-by-side into a screen or screens upon which a projected image of a fairway can preferably exist. Golf simulator technology, both hardware and software, can then display the simulated path of each competitor's struck shot on the screen(s), the final calculated distance of each competitor's struck shot, and possibly other pieces of pertinent data, including, but not limited to, calculated ball speed, height, curvature, and dispersion. Where the fairway appearing in the simulated environment may or may not represent an actual fairway at an existing facility, one or more actual real-world-like weather conditions (e.g. wind speed and direction, rain, etc.) can be programmed into the simulated environment to be included and factored into the competitive environment of an event.

The flow of data in a simulated environment can be the same as that of a live event contested on an outdoor fairway though preferably with the following exceptions:
1. The simulated environment can preferably eliminate the need for Relayed Spotter Data, Laser Measurement(s), Wind Gauge(s), and Shot Tracers (applied to the Broadcast feed).
2. The simulated environment may or may not require direct video recording of the screen(s), depending on the type of golf simulator used for each event/Broadcast.

When incorporating/using simulated environments into the event (FIG. 4), the actual flow of digital data between the systems can be almost exactly the same or highly similar to that shown in and described for FIG. 3, with the above exceptions noted in the preceding paragraph. Accordingly, the above disclosure for FIG. 3 is incorporated by reference for the description for FIG. 4, and particularly, though not limiting, for like components and like process flow appearing in both FIG. 3 and FIG. 4. Accordingly, the flow of digital data is virtually the same for simulated and non-simulated events in connection with the event, competitions, league operations, etc. Use of a golf simulator can allow for the elimination of live spotters, physical wind gauges, etc. All event and computer related data flows back-and-forth between the main servers as described with live outdoor events, with the golf simulator preferably replacing the shot tracer from FIG. 3. However, the overall flow and operation of each event can remain exactly the same for staff and competitors.

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device/system (e.g., any available computing device, including smart phones or other mobile devices that include computing hardware/software). Tangible computer-readable storage media are any available tangible media that can be accessed within a computing environment (e.g., one or more optical media discs such as DVD or CD, volatile memory components (such as DRAM or SRAM), databases, or nonvolatile memory components (such as flash memory or hard drives). The term computer-readable storage media preferably does not include signals and carrier waves. In addition, the term computer-readable storage media preferably does not include communication connections.

Any of the computer-executable instructions for implementing the disclosed techniques and operations of the league, including without limitation, Event scheduling, participant selection, league operations, odds making, Event conducting, Event broadcasting, etc., as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods and systems should not be construed as limiting in any way. Instead, the present disclosure is directed toward all novel and nonobvious features and aspects of the various disclosed embodiments, alone and in various combinations and sub combinations with one another. The disclosed methods and systems are not limited to any specific aspect or feature or combination thereof, nor do the disclosed embodiments require that any one or more specific advantages be present or problems be solved.

The technologies described herein can be combined with the technologies described in any one or more of the other examples. In view of the many possible embodiments to which the principles of the disclosed technology may be applied, it should be recognized that the illustrated embodiments are examples of the disclosed technology and use of such novel technology for operating and wagering on a novel sports league and should not be taken as a limitation on the scope of the disclosed technology or the operation of the novel sports league.

What is claimed is:

1. A method for selecting participants for an event or match hosted or conducted by a golf long-shot league, the golf long-shot league having multiple levels of golf swing speed ranges wherein only participants classified in a particular level of the multiple level of golf swing speed ranges compete against each other, the method comprising:
a. calculating a golf long-shot swing speed for each participant of the golf long-shot league;
b. assigning each participant to a particular level out of multiple levels of golf swing speed ranges based on a golf long-shot swing speed calculated for each participant in step a.; and
c. selecting a plurality of participants from all participants assigned to a same particular level of golf swing speed range in step b. to participate in a golf long-drive event or match against each other.

2. The method of claim 1 where the plurality of participants selected in step c. are selected regardless or independent of gender or age.

3. The method of claim 1 further comprising the step of providing information regarding each event or match hosted or conducted by the golf long-shot league and updating each participants' golf long-shot swing speed based on past performances in the event or match by each participant.

4. The method of claim 3 further comprising the step reassigning one or more participants to a new particular level of golf swing speed range where the updated golf long-shot swing speed for the one or more participants is lower or higher than a range of golf swing speed that they are currently assigned to.

5. The method of claim 1 further comprising the step of assigning odds to each participant selected for the golf long-drive event or match for betting purposes.

6. The method of claim 5 further comprising the step of forwarding a digital program to one or more recipients containing the assigned odds for one or more events or matches for a particular day.

7. The method of claim 1 further comprising the step of repeating step c. until a plurality of participants are selected for each level of the multiple levels of golf swing speed ranges.

8. The method of claim 1 further comprising the step of performing a golf long-shot swing by each participant that is used for the calculating the golf long-shot swing speed in step a. for each participant.

9. The method of claim 8 wherein the golf long-shot swing is performed at an existing outdoor event site.

10. The method of claim 8 wherein the golf long-shot swing is performed at an existing outdoor qualifying site.

11. The method of claim 8 wherein the golf long-shot swing is performed using a golf simulator device.

12. The method of claim 1 further comprising the step of operating a golf long-drive event after the plurality of participants are selected in step c.

13. The method of claim 12 wherein the golf long-drive event is held at one or more existing outdoor golf facilities.

14. The method of claim 13 wherein the one or more existing outdoor golf holes are associated with or from a single outdoor golf facility.

15. The method of claim 12 wherein the golf long-drive event is held and performed using a golf simulator device.
